(19) United States
(12) Patent Application Publication
(10) Pub. No.: US 2022/0367848 A1
(43) Pub. Date: Nov. 17, 2022

(54) DOUBLE-SIDED ELECTRODES AND ELECTROCHEMICAL CELLS INCLUDING THE SAME

(71) Applicant: GM GLOBAL TECHNOLOGY OPERATIONS LLC, Detroit, MI (US)

(72) Inventors: Dewen KONG, Shanghai (CN); Haijing LIU, Shanghai (CN); Meiyuan WU, Shanghai (CN); Xiaochao QUE, Shanghai (CN); Sherman H. ZENG, Troy, MI (US); Xiaosong HUANG, Novi, MI (US)

(73) Assignee: GM GLOBAL TECHNOLOGY OPERATIONS LLC, Detroit, MI (US)

(21) Appl. No.: 17/690,936

(22) Filed: Mar. 9, 2022

(30) Foreign Application Priority Data
May 12, 2021 (CN) 202110519549.1

(51) Int. Cl. H01M 4/137; H01M 4/36

(52) U.S. Cl. CPC H01M 4/137; H01M 4/366; H01M 2004/027

(57) ABSTRACT

The present disclosure provides an electrochemical cell that includes a double-sided electrode. The double-sided electrode includes a first electroactive material layer, a second electroactive material layer, and a current collector disposed between the first and second electroactive material layers. Each of the first and second electroactive material layers may include a plurality of electroactive material sub-films and a plurality of buffer layers disposed between adjacent electroactive material sub-films. The electrochemical cell further includes a first single-sided electrode substantially aligned with the first electroactive material layer; a first separator physically separating the first single-sided electrode and the first electroactive material layer; a second single-sided electrode substantially aligned with the second electroactive material layer; and a second separator physically separating the second single-sided electrode and the second electroactive material layer. The current collector may include at least one surface coated with an adhesive layer.

### CROSS-REFERENCE TO RELATED APPLICATIONS

This application claims the benefit and priority of Chinese Application No. 202110519549.1, filed May 12, 2021. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Often that at least two electrodes includes several cathodes and anodes that are stacked layer by layer and physically separated by separators. Such designs can include a high ratio of non-active materials, such as separators and current collectors. The high ratio of such non-active material can decrease cell energy density, as well as increasing costs and manufacturing challenges. Accordingly, it would be desirable to develop designs and materials, and methods of making and using the same, that can help to address these challenges.

### SUMMARY

This section provides a general summary of the disclosure, and is not a comprehensive disclosure of its full scope or all of its features.

The present disclosure relates to a double-sided electrode (for example, a double-sided positive electrode or cathode or double-sided negative electrode or anode) and an electrochemical cell including the same.

In various aspects, the present disclosure provides an electrochemical cell that cycles lithium ions. The electrochemical cell may include a double-sided electrode. The double-sided electrode may include a first electroactive material layer, a second electroactive material layer, and a current collector disposed between the first and second electroactive material layers. The electrochemical cell may further include a first single-sided electrode substantially aligned with the first electroactive material layer; a first separator physically separating the first single-sided electrode and the first electroactive material layer; a second single-sided electrode substantially aligned with the second electroactive material layer; and a second separator physically separating the second single-sided electrode and the second electroactive material layer.

In one aspect, each of the first and second electroactive material layers may include a positive electroactive material, and each of the first and second single-sided electrodes may include a negative electroactive material.

In one aspect, each of the first and second electroactive material layers may include a negative electroactive material, and each of the first and second single-sided electrodes may include a positive electroactive material.

In one aspect, the current collector is a first current collector, a second current collector may be disposed on or adjacent to the first single-sided electrode, and a third current collector may be disposed on or adjacent to the second single-sided electrode.

In one aspect, the first electroactive material layer may include a plurality of first electroactive material sub-films and a plurality of first buffer layers. The first buffer layers may be disposed between adjacent electroactive sub-films of the plurality of first electroactive sub-films.

In one aspect, the second electroactive material layer may include a plurality of second electroactive material sub-films and a plurality of second buffer layers. The second buffer layers may be disposed between adjacent electroactive material sub-films of the plurality of second electroactive sub-films.

In one aspect, the plurality of first buffer layers and the plurality of second buffer layers may each include a polymer, an electronically conductive filler, and an ionically conductive filler.

In one aspect, the current collector may have one or more surfaces coated with an adhesive layer. The adhesive layer may have a thickness greater than or equal to about 0.05 μm to less than or equal to less than or equal to about 100 μm. The adhesive layer may include a polymer and an electronically conductive filler.

In one aspect, the electrochemical cell may further include a first terminal separator disposed on or adjacent to an exposed surface of the first single-sided electrode, and a second terminal separator disposed on or adjacent to an exposed surface of the second single-sided electrode.

In various aspects, the present disclosure provides an electrochemical cell that cycles lithium ions. The electrochemical cell may include a double-sided electrode. The double-sided electrode may include a first electroactive material layer, a second electroactive material layer, and a current collector disposed between the first and second electroactive material layers. The first electroactive material layer may include a plurality of first electroactive material sub-films and a plurality of first buffer layers. The buffer layers may be disposed between adjacent electroactive sub-films of the plurality of first electroactive sub-films. The second electroactive material layer may include a plurality of second electroactive material sub-films and a plurality of second buffer layers. The plurality of second buffer layers may be disposed between adjacent electroactive material sub-films of the plurality of second electroactive sub-films. The electrochemical cell may further include a first single-sided electrode substantially aligned with the first electroactive material layer; a first separator physically separating the first single-sided electrode and the first electroactive material layer; a second single-sided electrode substantially aligned with the second electroactive material layer; and a second separator physically separating the second single-sided electrode and the second electroactive material layer.

In one aspect, the current collector is a first current collector, a second current collector may be disposed on or adjacent to the first single-sided electrode, and a third current collector may be disposed on or adjacent to the second single-sided electrode.

In one aspect, the plurality of first buffer layers and the plurality of second buffer layers may each include a polymer, an electronically conductive filler, and an ionically conductive filler.

In one aspect, the current collector may have one or more surfaces coated with an adhesive layer. The adhesive layer may have a thickness greater than or equal to about 0.05 μm to less than or equal to less than or equal to about 100 μm.

In one aspect, the electrochemical cell may further include a first terminal separator disposed on or adjacent to an exposed surface of the first single-sided electrode; and a second terminal separator disposed on or adjacent to an exposed surface of the second single-sided electrode.

In various aspects, the present disclosure provides a double-sided electrode for an electrochemical cell that cycles lithium ions. The electrode may include a current collector having a first surface substantially parallel with a second surface; a first electroactive material layer disposed on or adjacent to the first surface of the current collector; and a second electroactive material layer disposed on or adjacent to the second surface of the current collector. The first electroactive material layer may include a plurality of first electroactive material sub-films and a plurality of first buffer layers. The first buffer layers may be disposed between adjacent electroactive sub-films of the plurality of first electroactive sub-films. The second electroactive material layer may include a plurality of second electroactive material sub-films and a plurality of second buffer layers. The second buffer layers may be disposed between adjacent electroactive material sub-films of the plurality of second electroactive sub-films. The double-sided electrode may have a total thickness greater than or equal to about 100 μm to less than or equal to about 20,000 μm.

In one aspect, each of the first and second electroactive material layers may include a positive electroactive material.

In one aspect, each of the first and second electroactive material layers may include a negative electroactive material.

In one aspect, the plurality of first buffer layers and the plurality of second buffer layers may each include a polymer, an electronically conductive filler, and an ionically conductive filler.

In one aspect, each of the plurality of first electroactive material sub-films and the plurality of second electroactive material sub-films may respectively have a thickness greater than or equal to about 100 μm to less than or equal to about 1,000 μm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example sole electrode battery in accordance with various aspects of the present disclosure;

FIG. 2A is an illustration of an example positive electrode in accordance with various aspects of the present disclosure;

FIG. 2B is another illustration of an example positive electrode in accordance with various aspects of the present disclosure;

FIG. 3 is a schematic of another example sole electrode battery in accordance with various aspects of the present disclosure;

FIG. 4A is an illustration of an example negative electrode in accordance with various aspects of the present disclosure;

FIG. 4B is another illustration of an example negative electrode in accordance with various aspects of the present disclosure; and

FIG. 5 is a graphical illustration demonstrating the capacity retention of an example half-cell preparing in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure provides an electrochemical cell (e.g., sole-electrode battery) design that reduces the weight and volume of non-active materials (e.g., current collectors, separators, and the like), such that the battery has improved energy density (e.g., about 255.5 wh/kg or 521.0 wh/L), as well as provides means for simplifying cell assembly and manufacturing.

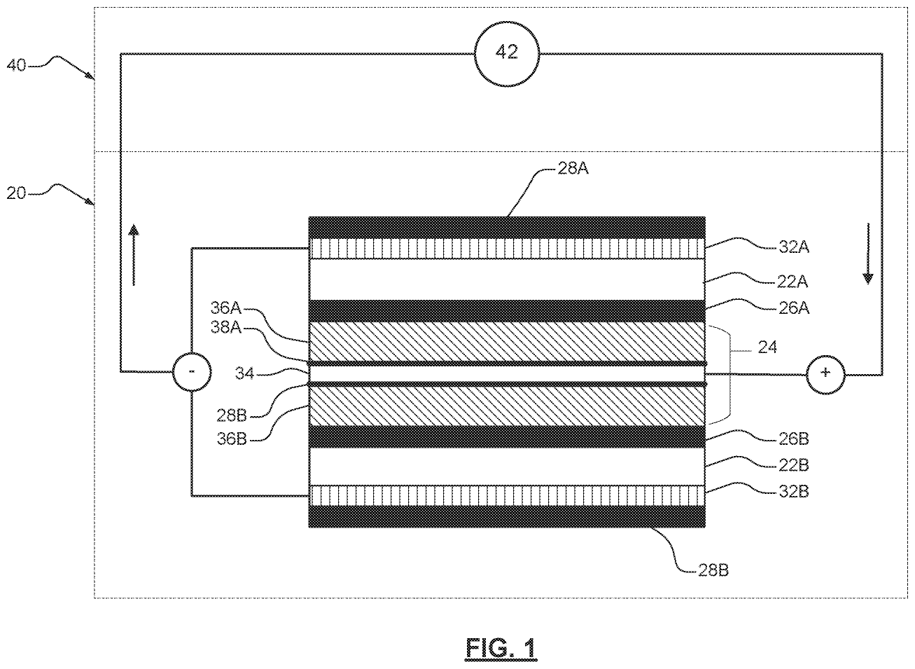

A typical lithium-ion, sole electrode battery (e.g., electrochemical cell that cycles lithium ions) includes a double-sided electrode disposed between parallel first and second single-sided electrodes, where a separator and/or electrolyte physically separates the double-sided electrode and the first and second single-sided electrodes. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, exemplary and schematic illustration of an electrochemical cell (also referred to as a battery) 20 having a cell capacity greater than or equal to about 20 Ah to less than or equal to about 300 Ah, and in certain aspects, optionally greater than or equal to about 65 Ah to less than or equal to about 150 Ah, is shown in FIG. 1.

Such cells are used in vehicle or automotive transportation applications (e.g., motorcycles, boats, tractors, buses, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include only one cathode and two anodes, or two cathode and one anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a double-sided positive electrode 24 (e.g., cathode) disposed between parallel first and second single-sided negative electrodes 22A, 22B (e.g., anodes). A first separator 26A may be disposed between the first single-sided negative electrode 22A and a first side of the double-sided positive electrode 24. A second separator 26B may be disposed between the second single-sided negative electrode 22B and a second side of the double-sided positive electrode 24. The first and second sides of the double-sided positive electrode 24 may be substantially parallel sides. The separators 26A, 26B provide electrical separation (i.e., prevents physical contact) between the electrodes 22A, 22B, 24. The separators 26A, 26B also provide a minimal resistance path for internal passage of lithium ions, and in certain instances, related anions, during cycling of the lithium ions. In various aspects, the separator 26 comprises an electrolyte (not shown) that may, in certain aspects, also be present in the negative electrodes 22A, 22B and the positive electrode 24. In certain variations, the separators 26A, 26B may be a solid-state electrolyte. For example, the separators 26A, 26B may be defined by a plurality of solid-state electrolyte particles (not shown).

Negative electrode current collectors 32A, 32B may be positioned at or near each of the negative electrodes 22A, 22B. For example, a first negative electrode current collector 32A may be positioned at or near the first single-sided negative electrode 22A, and a second negative electrode current collector 32B may be positioned at or near the second single-sided negative electrode 22B. The first and second negative electrode current collectors 32A, 32B may be the same or different. The first and second negative electrode current collectors 32A, 32B may each be a metal foil, metal mesh, grid, or screen, or expanded metal comprising copper, stainless steel, or any other appropriate electrically conductive material known to those of skill in the art. In certain variations, the negative electrode current collectors 32A, 32B may have a surface treatment. For example, the negative electrode current collectors 32A, 32B may be carbon coated or etched. In each instance, the negative electrode current collectors 32A, 32B may have a thickness greater than or equal to about 5 μm to less than or equal to about 200 μm, and in certain aspects, optionally greater than or equal to about 20 μm to less than or equal to about 100 μm.

The double-sided positive electrode 24 may include a positive electrode current collector 34. For example, the positive electrode 24 may include a first positive electroactive material layer 36A disposed adjacent a first surface of the positive electrode current collector 34, and a second positive electroactive material layer 36B disposed adjacent a second surface of the positive electrode current collector 34. The first and seconds sides of the positive electrode current collector 34 may be substantially parallel sides. The first positive electroactive material layer 36A may define a first side of the double-sided positive electrode 24. The second positive electroactive material layer 36B may define a second side of the double-sided positive electrode 24. The positive electrode current collector 34 may be a metal foil, metal mesh, grid, or screen, or expanded metal comprising aluminum or any other appropriate electrically conductive material known to those of skill in the art. In each instance, the positive electrode current collector 34 may have a thickness greater than or equal to about 5 μm to less than or equal to about 200 μm, and in certain aspects, optionally greater than or equal to about 20 μm to less than or equal to about 100 μm.

In certain variations, the positive electrode current collector 34 may have a surface treatment. For example, the positive electrode current collector 34 may be carbon coated or etched. In other variations, as illustrated, a first adhesive layer 38A may be disposed on or adjacent to the first surface of the positive electrode current collector 34, and a second adhesive layer 38B may be disposed on or adjacent to the second surface of the positive electrode current collector 34.

The first and second adhesive layers 38A, 38B may each have a thickness greater than or equal to about 0.05 μm to less than or equal to less than or equal to about 100 μm, optionally greater than or equal to about 0.05 μm to less than or equal to less than or equal to about 50 μm, and in certain variations, greater than or equal to about 1 μm to less than or equal to about 10 μm, with a thickness variation of about ±5%. The first and second adhesive layers 38A, 38B may each have a porosity greater than or equal to about 0.1 vol. % to less than or equal to about 0.5 vol. %, and in certain aspects, optionally greater than or equal to about 0.15 vol. % to less than or equal to about 0.3 vol. %.

The first and second adhesive layers 38A, 38B may be electrically conductive layers that include an admixture of a polymer and an electronic conductive filler. For example, the first and second adhesive layers 38A, 38B may each include greater than or equal to about 0.1 wt. % to less than or equal to about 50 wt. % of a polymer, and greater than or equal to about 0.1 wt. % to less than or equal to about 50 wt. % of an electronic conductive filler. For example, the first and second adhesive layers 38A, 38B may have a mass ratio of the conductive filler:polymer of about 1:3. The conductive filler may include a carbonaceous material (such as, Super-P, carbon black, graphene, carbon nanotubes, and the like) and/or metal powders. The polymer may be solvent resistant and provides good adhesion, such as epoxy, polyimide (polyamic acid), polyester, vinyl ester, and combinations and the like. In other variations, the polymer may include a thermoplastic polymer, such as polyvinylidene fluoride (PVdF), polyamide, silicone, acrylic, and combinations and the like.

The negative electrode current collectors 32A, 32B and the positive electrode current collector 34 respectively collect and move free electrons to and from an external circuit 40. For example, an interruptible external circuit 40 and a load device 42 may connect the negative electrodes 22A, 22B (through the negative electrode current collectors 32A, 32B) and the positive electrode 24 (through the positive electrode current collector 34).

The battery 20 can generate an electric current during discharge by way of reversible electrochemical reactions that occur when the external circuit 40 is closed (to connect the negative electrodes 22A, 22B and the positive electrode 24) and the negative electrodes 22A, 22B have a lower potential than the positive electrode 24. In certain variations, the battery 20 may have a negative electrode capacity for lithium to positive electrode capacity for lithium (N/P) ratio of greater than or equal to about 1.01 to less than or equal to about 1.3, and in certain aspects, optionally greater than or equal to about 1.05 to less than or equal to about 1.2. The chemical potential difference between the positive electrode 24 and the negative electrodes 22A, 22B drives electrons produced by a reaction, for example, the oxidation of intercalated lithium, at the negative electrodes 22A, 22B through the external circuit 40 towards the positive electrode 24. Lithium ions that are also produced at the negative electrodes 22A, 22B are concurrently transferred through the electrolyte contained in the separator 26 towards the positive electrode 24. The electrons flow through the external circuit 40 and the lithium ions migrate across the separator 26 containing the electrolyte to form intercalated lithium at the positive electrode 24. As noted above, electrolyte is typically also present in the negative electrodes 22A, 22B and the positive electrode 24. The electric current passing through the external circuit 40 can be harnessed and directed through the load device 42 until the lithium in the negative electrodes 22A, 22B is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous reaction at the positive electrode 24 so that electrons and lithium ions are produced. The lithium ions flow back towards the negative electrodes 22A, 22B through the electrolyte across the separator 26 to replenish the negative electrodes 22A, 22B with lithium (e.g., intercalated lithium) for use during the next battery discharge event. As such, a complete discharging event followed by a complete charging event is considered to be a cycle, where lithium ions are cycled between the positive electrode 24 and the negative electrodes 22A, 22B. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collectors 32A, 32B, the negative electrodes 22A, 22B, the separators 26A, 26B, the positive electrode 24, and the positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrodes 22A, 22B, the positive electrode 24, and/or the separators 26A, 26B. The battery 20 shown in FIG. 1 includes a liquid electrolyte and shows representative concepts of battery operation. However, the present technology also applies to solid-state batteries that include solid-state electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrodes 22A, 22B, and the separators 26A, 26B may each include an electrolyte solution or system (not shown) inside their pores, capable of conducting lithium ions between the negative electrodes 22A, 22B and the positive electrode 24. Any appropriate electrolyte, whether in solid, liquid, or gel form, capable of conducting lithium ions between the negative electrodes 22A, 22B and the positive electrode 24 may be used in the lithium-ion battery 20. In certain aspects, the electrolyte may be a non-aqueous liquid electrolyte solution (e.g., >1M) that includes a lithium salt dissolved in an organic solvent or a mixture of organic solvents. In certain instances, the electrolyte may also include one or more additives, such as vinylene carbonate (VC), butylene carbonate (BC), fluoroethylene carbonate (FEC), and the like. Numerous conventional non-aqueous liquid electrolyte solutions may be employed in the lithium-ion battery 20.

In certain aspects, the electrolyte may be a non-aqueous liquid electrolyte solution that includes one or more lithium salts dissolved in an organic solvent or a mixture of organic solvents. The lithium salts may include one or more cations coupled with one or more anions. The cations may be selected from Li⁺, Na⁺, K⁺, Al³⁺, Mg²⁺, and the like. The anions may be selected from PF⁶⁻, BF⁴⁻, TFSI⁻, FSI⁻, CF₃SO₃₋, (C₂F₅S₂O₂)N⁻, and the like. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium oxalyldifluoroborate (LiODFB), lithium fluoroalkylphosphate (LiFAP), lithium hexafluoroarsenate (LiAsF₆), lithium bis(trifluoromethanesulfonyl)imide (LiTFSI), lithium bis(fluorosulfonyl)imide (LiFSI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The first and second porous separators 26A, 26B may be the same or different. In each instance, the porous separator 26A, 26B may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes include CELGARD® 2500 (a monolayer polypropylene separator) and CELGARD® 2320 (a trilayer polypropylene/polyethylene/polypropylene separator) available from Celgard LLC.

In certain aspects, the separator 26A, 26B may further include one or more of a ceramic coating layer and a heat-resistant material coating. The ceramic coating layer and/or the heat-resistant material coating may be disposed on one or more sides of the separator 26A, 26B. The material forming the ceramic layer may be selected from the group consisting of: boehmite (AlOOH), alumina (Al₂O₃), silica (SiO₂), and combinations thereof. The heat-resistant material may be selected from the group consisting of: Nomex, Aramid, and combinations thereof.

When the separator 26A, 26B is a microporous polymeric separator, it may be a single layer or a multi-layer laminate, which may be fabricated from either a dry or a wet process. For example, in certain instances, a single layer of the polyolefin may form the entire separator 26A, 26B. In other aspects, the separator 26A, 26B may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26A, 26B. The separator 26A, 26B may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26A, 26B as a fibrous layer to help provide the separator 26A, 26B with appropriate structural and porosity characteristics. Various conventionally available polymers and commercial products for forming the separator 26A, 26B are contemplated, as well as the many manufacturing methods that may be employed to produce such a microporous polymer separator 26A, 26B. Each separator 26A, 26B may have a thickness greater than or equal to about 1 μm to less than or equal to about 50 μm, and in certain instances, optionally greater than or equal to about 1 μm to less than or equal to about 20 μm.

In certain variations, the battery 20 may further include one or more terminal separators 28A, 28B. For example, the battery 20 may include a first terminal separator 28A disposed on or adjacent to an exposed surface of the first negative electrode current collector 32A, and a second terminal separator 28B disposed on or adjacent to an exposed surface of the second negative electrode current collector 32B. The terminal separators 28A, 28B may physically separator the current collectors 32A, 32B and the battery casing or housing (not shown). The terminal separators 28A, 28B may be the same as or different from the first separator 26A and/or the second separator 26B

In various aspects, the porous separators 26A, 26B, 28A, 28B and the electrolyte disposed in the porous separators 26A, 26B, 28A, 28B in FIG. 1 may each be replaced with a solid-state electrolyte (“SSE”) (not shown) that functions as both an electrolyte and a separator. The solid-state electrolytes may be disposed between the positive electrode 24 and negative electrodes 22A, 22B. The solid-state electrolytes facilitate transfer of lithium ions, while mechanically separating and providing electrical insulation between the negative electrodes 22A, 22B and the positive electrode 24. By way of non-limiting example, solid-state electrolytes may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The solid-state electrolyte particles may be nanometer sized oxide-based solid-state electrolyte particles. In still other variations, the porous separators 26A, 26B, and the electrolyte, in FIG. 1 may be replaced with a gel electrolyte. In certain variations, the porous separators 28A, 28A in FIG. 1 may be replaced with a plastic film.

Each of the single-sided negative electrodes 22A, 22B comprises a lithium host material that is capable of functioning as a negative terminal of a lithium-ion battery. For example, the negative electrodes 22A, 22B may each comprise a lithium host material (e.g., negative electroactive material) that is capable of functioning as a negative terminal of the battery 20. In various aspects, each of the negative electrodes 22A, 22B may be defined by a plurality of negative electroactive material particles (not shown). Such negative electroactive material particles may be disposed in one or more layers so as to define the three-dimensional structure of the negative electrodes 22A, 22B. The electrolyte may be introduced, for example after cell assembly, and contained within pores (not shown) of the negative electrodes 22A, 22B. For example, the negative electrodes 22A, 22B may include a plurality of electrolyte particles (not shown). Each of the negative electrodes 22A, 22B (including the one or more layers) may have a thickness greater than or equal to about 1,000 μm to less than or equal to about 1 cm, and in certain aspects, optionally greater than or equal to about 2,000 μm to less than or equal to about 5,000 μm, with a thickness variation of about ±5%.

The first and second single-sided negative electrodes 22A, 22B may be the same or different (e.g., compositionally). For example, each of the negative electrodes 22A, 22B may include a negative electroactive material that comprises lithium, such as, for example, lithium metal. In certain variations, the negative electrodes 22A, 22B may be film or layer formed of lithium metal or an alloy of lithium. Other materials can also be used to form the negative electrodes 22A, 22B, including, for example, carbonaceous materials (such as, graphite, hard carbon, soft carbon, carbon nanotubes (CNT), and the like) and/or lithium-silicon and silicon containing binary and ternary alloys and/or tin-containing alloys (such as, Si, Li—Si, SiOₓ,Si—Sn, SiSnFe, SiSnAl, SiFeCo, SnO₂, and the like) and/or metal oxides (such as, Fe₃O₄, V₂O₅, SnO, Co₃O₄, NbOₓ, and the like) and/or metal sulfides (such as, FeS and the like). In certain variations, lithium-titanium anode materials are contemplated, such as Li₄₊ₓTi₅O₁₂, where 0≤x≤3, including lithium titanate (Li₄Ti₅O₁₂) (LTO).

The negative electroactive material may be optionally intermingled with one or more electrically conductive materials that provide an electron conductive path and/or at least one polymeric binder material that improves the structural integrity of the negative electrodes 22A, 22B. For example, the negative electroactive material in one or both of the negative electrode 22A, 22B may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black (e.g., Super-P), graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like.

For example, each of the negative electrodes 22A, 22B may include greater than or equal to about 30 wt. % to less than or equal to about 99.5 wt. %, and in certain aspects, optionally greater than or equal to about 50 wt. % to less than or equal to about 98 wt. %, of the negative electroactive material; greater than or equal to about 0 wt. % to less than or equal to about 30 wt. %, and in certain aspects, optionally greater than or equal to about 0.5 wt. % to less than or equal to about 10 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The negative electrodes 22A, 22B may have an electrode press density greater than or equal about 1.0 g/cc to less than or equal to about 3.0 g/cc, and in certain aspects, optionally greater than or equal to about 1.3 g/cc to less than or equal to about 2.0 g/cc, with a variation of about ±3%.

As noted above, the double-sided positive electrode 24 includes a first positive electroactive material layer 36A disposed adjacent a first surface of the positive electrode current collector 34, and a second positive electroactive material layer 36B disposed adjacent a second surface of the positive electrode current collector 34. Each of the first and second positive electroactive material layers 36A, 36B may be formed from a lithium-based active material that is capable of undergoing lithium intercalation and deintercalation, alloying and dealloying, or plating and stripping, while functioning as the positive terminal of the battery 20. For example, each of the first and second positive electroactive material layers 36A, 36B can be defined by a plurality of electroactive material particles (not shown) disposed in one or more layers so as to define the three-dimensional structure of the positive electrode 24. The electrolyte may be introduced, for example after cell assembly, and contained within pores (not shown) of the positive electrode 24.

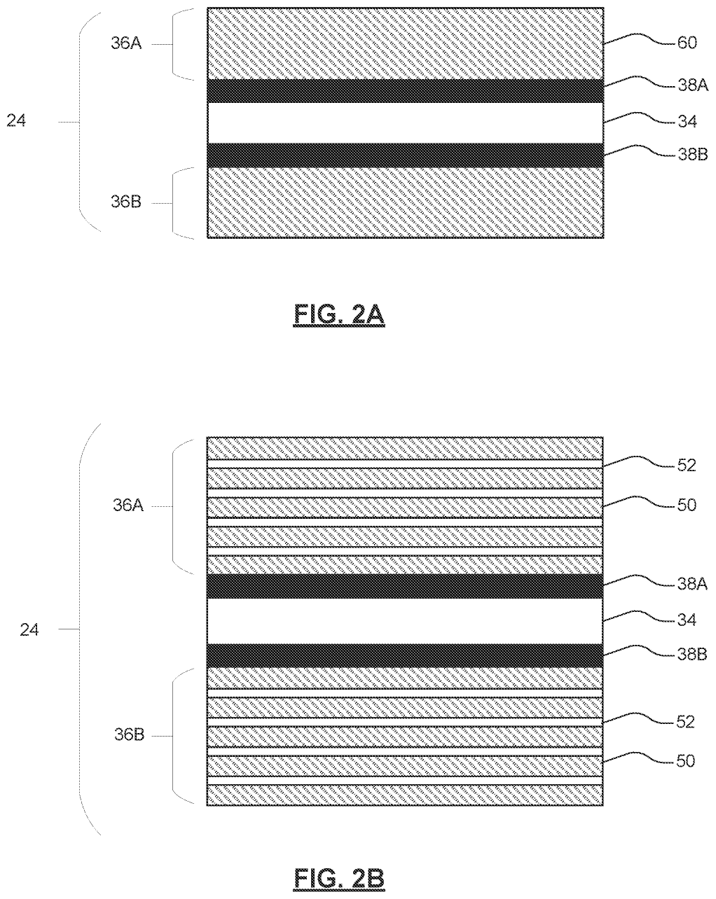

The first and second positive electroactive material layers 36A, 36B may be the same or different (e.g., compositionally). For example, in certain variations, as illustrated in FIG. 2A, each of the first and second positive electroactive material layers 36A, 26B may each include a positive electroactive material layer 60 having a thickness greater than or equal to about 500 μm to less than or equal to about 10,000 μm, optionally greater than or equal to about 1,000 μm to less than or equal to about 5,000 μm, and in certain aspects, optionally about 2,250 μm, with a variance of about ±5%. The double-sided positive electrode 24 may have a total thickness greater than or equal to about 100 μm to less than or equal to about 20,000 μm.

In each instance, the positive electroactive material layer 60 may include a positive electroactive material that comprises one or more materials having a spinel structure, such as lithium manganese oxide (Li₍₁₊ₓ₎Mn₂O₄, where 0≤x≤1), lithium manganese nickel oxide (LiMn₍₂₋ₓ₎NiₓO₄, where 0≤x≤0.5) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) or Li(NiₓMn_{y}Co_{z}Al_{w})O₂, where 0≤x≤1, 0≤y≤1, 0≤z≤1, 0≤w≤1 and x+y+z+w=1) (e.g., LiMn_{0.04}Ni_{0.90}Co_{0.04}Al_{0.02}O₂)), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄), lithium manganese-iron phosphate (LiMn₁₋ₓFeₓPO₄, where 0<x<0.5), or lithium iron fluorophosphate (Li₂FePO₄F). In certain variations, the positive electroactive material layer 60 may include one or more high-voltage oxides (such as, LiNi_{0.5}Mn_{1.5}O₄, LiCoPO₄), one or more rock salt layered oxides (such as, LiCoO₂, LiNiₓMn_{y}Co_{1-x-y}O₂ (where 0≤x≤1, 0≤y≤1), LiNiₓCO_{y}Al_{1-x-y}O₂ (where 0≤x≤1, 0≤y≤1), LiNiₓMn₁₋ₓO₂ (where 0≤x≤1), Li₁₊ₓMO₂ (where 0≤x≤2 and where M refers to metal elements selected from Mn, Ni, Co, and the like), one or more polyanions (such as, LiV₂(PO₄)₃), and other like lithium transition metal oxides.

For example, in various aspects, the positive electroactive material layer 60 may include one or more positive electroactive material selected from the group consisting of: LiCoO₂, LiNiO₂, LiMnO₂, LiNi_{0.5}Mn_{0.5}O₂, NMC111, NMC523, NMC622, NMC721, NMC811, NCA, NCMA, LiMn₂O₄, LiNi_{0.5}Mn_{1.5}O₄, LiV₂(PO₄)₃, LiFePO₄, LiCoPO₄, LiMnPO₄, LiVPO₄F, LiFeBO₃, LiCoBO₃, LiMnBO₃, Li₂FeSiO₄, Li₂MnSiO₄, LiMnSiO₄F, dilithium (2,5-dilithiooxy)terephthalate, polyimide, and combination thereof. In certain variations, the positive electroactive material particles may be surface coated and/or doped. For example, the positive electroactive material may include LiNbO₃-coated LiNi_{0.5}Mn_{1.5}O₄.

In each instance, the positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black or SuperP™), carbon fibers and nanotubes, graphene, graphene oxide, and the like. Examples of a conductive polymer include polyaniline, polythiophene, polyacetylene, polypyrrole, and the like. In certain aspects, mixtures of the conductive materials may be used.

For example, the positive electroactive material layer 60 may include greater than or equal to about 30 wt. % to less than or equal to about 99 wt. %, and in certain aspects, optionally greater than or equal to about 50 wt. % to less than or equal to about 98 wt. %, of the positive electroactive material; greater than or equal to about 0 wt. % to less than or equal to about 30 wt. %, and in certain aspects, optionally greater than or equal to about 1 wt. % to less than or equal to about 10 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders. The positive electroactive material film may have an electrode press density greater than or equal to about 1.0 g/cc to less than or equal to about 4.0 g/cc, and in certain aspects, optionally greater than to equal to about 1.7 g/cc to less than or equal to about 3.7 g/cc, with a variance of about ±3%.

In other variations, as illustrated in FIG. 2B, the first and second positive electroactive material layers 36A, 26B may each include a plurality of electroactive material sub-films or sub-layers 50, each sub-film 50 having a thickness greater than or equal to about 100 μm to less than or equal to about 1,000 μm, and in certain aspects, optionally greater than or equal to about 200 μm to less than or equal to about 600 μm, with a thickness variance of about ±3%. For example, in certain variations, as illustrated, the first and second positive electroactive material layers 36A, 36B may each include five sub-films 50. Each sub-film of the plurality of sub-films 50 may be the same or different (e.g., compositionally).

Like the positive electroactive material layer 60, each of the sub-layers 50 may include one or more positive electroactive material selected from the group consisting of: LiCoO₂, LiNiO₂, LiMnO₂, LiNi_{0.5}Mn_{0.5}O₂, NMC111, NMC523, NMC622, NMC721, NMC811, NCA, NCMA, LiMn₂O₄, LiNi_{0.5}Mn1.5O₄, LiV₂(PO₄)₃, LiFePO₄, LiCoPO₄, LiMnPO₄, LiVPO₄F, LiFeBO₃, LiCoBO₃, LiMnBO₃, Li₂FeSiO₄, Li₂MnSiO₄, LiMnSiO₄F, dilithium (2,5-dilithiooxy)terephthalate, polyimide, and combination thereof. In certain variations, the positive electroactive material particles may be surface coated and/or doped. For example, the positive electroactive material may include LiNbO₃-coated LiNi_{0.5}Mn_{1.5}O₄.

Each of the sub-layers 50 may also similarly include an electronically conducting material and/or at least one polymeric binder. For example, each sub-layer 50 may include greater than or equal to about 30 wt. % to less than or equal to about 99 wt. %, and in certain aspects, optionally greater than or equal to about 50 wt. % to less than or equal to about 98 wt. %, of the positive electroactive material; greater than or equal to about 0 wt. % to less than or equal to about 30 wt. %, and in certain aspects, optionally greater than or equal to about 1 wt. % to less than or equal to about 10 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

As illustrated, subsequent sub-films 50 may be separated by one or more buffer or adhesive layers 52 having a porosity greater than or equal to about 0.2 vol. % to less than or equal to about 0.7 vol. %, and in certain aspects, optionally greater than or equal to about 0.25 vol. % to less than or equal to about 0.5 vol. %. For example, as illustrated, an adhesive layer 52 may be disposed between of the sequential sub-films 50. In each instance, the one or more adhesive layers 52 may be an ionically and electrically conductive layer that include an admixture of a polymer, an electronically conductive filler, and an ionically conductive filler. For example, each of the one or more adhesive layers 52 may include greater than or equal to about 0.1 wt. % to less than or equal to about 50 wt. % of the polymer and greater than or equal to about 0.1 wt. % to less than or equal to about 50 wt. % of a combination of the electronically conductive filler and the ionically conductive filler. In certain variations, at least one of the one or more adhesive layers 52 may have a mass ratio of the polymer:electronically conductive filler:ionically conductive filler of about 3:1:1.

The electrically conductive filler may include a carbonaceous material (such as, Super-P, carbon black, graphene, carbon nanotubes, carbon nanofibers, and the like) and/or metal powders (such as, silver (Ag), aluminum (Al), nickel (Ni), and the like). The ionically conductive filler may include a lithium-ion fast conductive material, such as lithium aluminum titanium phosphate (LATP), lithium lanthanum zirconate (LLZO), Li₁₊ₓAlₓGe₂₋ₓ(PO₄)₃ (where 0≤x≤2) (LAGP), and the like. The polymer may be solvent resistant and provides good adhesion, such as epoxy, polyimide (polyamic acid), polyester, vinyl ester, and combinations and the like. In other variations, the polymer may include a thermoplastic polymer, such as polyvinylidene fluoride (PVdF), polyamide, silicone, acrylic, and combinations and the like.

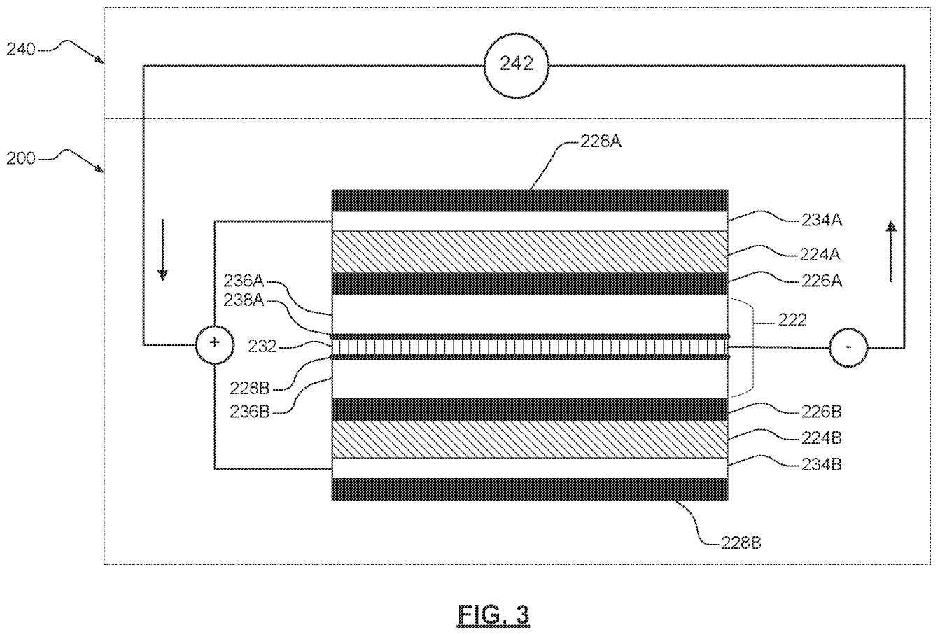

FIG. 3 illustrates another example electrochemical cell (also referred to as a battery) 220 having a cell capacity greater than or equal to about 20 Ah to less than or equal to about 300 Ah, and in certain aspects, optionally greater than or equal to about 65 Ah to less than or equal to about 150 Ah. The battery 200 includes a double-sided negative electrode 222 (e.g., anode) disposed between parallel first and second single-sided positive electrodes 224A, 224B (e.g., cathodes). A first separator 226A may be disposed between the first single-sided positive electrode 224A and a first side of the double-sided negative electrode 222. A second separator 226A may be disposed between the second single-sided positive electrode 224B and a second side of the double-sided negative electrode 224. The first and second sides of the double-sided negative electrode 222 may be substantially parallel sides.

Like separators 26A, 26B illustrated in FIG. 1, the separators 226A, 226B illustrated in FIG. 3 provide electrical separation (i.e., prevents physical contact) between the electrodes 222, 224A, 224B. The separators 226A, 226B also provide a minimal resistance path for internal passage of lithium ions, and in certain instances, related anions, during cycling of the lithium ions. In various aspects, the separator 226 comprises an electrolyte solution or system (not shown) that may, in certain aspects, also be present in the positive electrodes 224A, 224B and the negative electrode 24. Any appropriate electrolyte, whether in solid, liquid, or gel form, capable of conducting lithium ions between the positive electrodes 224A, 224B and the negative electrode 222 may be used in the lithium-ion battery 20.

In certain variations, the battery 200 may further include one or more terminal separators 228A, 228B. For example, the battery 200 may include a first terminal separator 228A disposed on or adjacent to an exposed surface of the first positive electrode current collector 234A, and a second terminal separator 228B disposed on or adjacent to an exposed surface of the second positive electrode current collector 234B. The terminal separators 228A, 228B may physically separator the current collectors 234A, 234B and the battery casing or housing (not shown). The terminal separators 228A, 228B may be the same as or different from the first separator 226A and/or the second separator 226B.

Positive electrode current collectors 234A, 234B may be positioned at or near each of the positive electrodes 224A, 224B. For example, a first negative electrode current collector 234A may be positioned at or near the first single-sided positive electrode 224A, and a second positive electrode current collector 234B may be positioned at or near the second single-sided positive electrode 224B. The first and second positive electrode current collectors 234A, 234B may be the same or different. The first and second positive electrode current collectors 234A, 234B may each be a metal foil, metal mesh, grid, or screen, or expanded metal comprising aluminum or any other appropriate electrically conductive material known to those of skill in the art. In certain variations, the positive electrode current collectors 234A, 234B may have a surface treatment. For example, the positive electrode current collectors 234A, 234B may be carbon coated or etched. In each instance, the positive electrode current collectors 234A, 234B may have a thickness greater than or equal to about 5 μm to less than or equal to about 200 μm, and in certain aspects, optionally greater than or equal to about 20 μm to less than or equal to about 100 μm.

The double-sided negative electrode 222 may include a negative electrode current collector 232. For example, the negative electrode 222 may include a first negative electroactive material layer 236A disposed adjacent a first surface of the negative electrode current collector 232, and a second negative electroactive material layer 236B disposed adjacent a second surface of the negative electrode current collector 232. The first and seconds sides of the negative electrode current collector 232 may be substantially parallel sides. The first negative electroactive material layer 236A may define a first side of the double-sided negative electrode 222. The second negative electroactive material layer 236B may define a second side of the double-sided negative electrode 222. The negative electrode current collector 232 may be a metal foil, metal mesh, grid, or screen, or expanded metal comprising aluminum or any other appropriate electrically conductive material known to those of skill in the art. In each instance, the negative electrode current collector 232 may have a thickness greater than or equal to about 4 μm to less than or equal to about 200 μm, and in certain aspects, optionally greater than or equal to about 20 μm to less than or equal to about 100 μm.

In certain variations, the negative electrode current collector 232 may have a surface treatment. For example, the negative electrode current collector 232 may be carbon coated or etched. In other variations, as illustrated, a first adhesive layer 238A may be disposed on or adjacent to the first surface of the negative electrode current collector 232, and a second adhesive layer 238B may be disposed on or adjacent to the second surface of the negative electrode current collector 234.

The first and second adhesive layers 238A, 238B may have a thickness greater than or equal to about 0.05 μm to less than or equal to less than or equal to about 100 μm, optionally greater than or equal to about 0.05 μm to less than or equal to less than or equal to about 50 μm, and in certain variations, greater than or equal to about 1 μm to less than or equal to about 10 μm, with a thickness variance of about ±3%. The first and second adhesive layers 238A, 238B may be electrically conductive layers that include an admixture of a polymer and an electronic conductive filler. For example, the first and second adhesive layers 238A, 238B may each include greater than or equal to about 0.1 wt. % to less than or equal to about 50 wt. % of a polymer, and greater than or equal to about 0.1 wt. % to less than or equal to about 50 wt. % of an electronic conductive filler. For example, the first and second adhesive layers 238A, 238B may have a mass ratio of the conductive filler:polymer of about 1:3. The conductive filler may include a carbonaceous material (such as, Super-P, carbon black, graphene, carbon nanotubes, and the like) and/or metal powders. The polymer may be solvent resistant and provides good adhesion, such as epoxy, polyimide (polyamic acid), polyester, vinyl ester, and combinations and the like. In other variations, the polymer may include a thermoplastic polymer, such as polyvinylidene fluoride (PVdF), polyamide, silicone, acrylic, and combinations and the like.

Like the negative electrode current collectors 32A, 32B and the positive electrode current collector 34 illustrated in FIG. 1, the negative electrode current collector 232 and the positive electrode current collectors 234A, 234B as illustrated in FIG. 3 respectively collect and move free electrons to and from an external circuit 40. For example, an interruptible external circuit 240 and a load device 242 may connect the negative electrode 222 (through the negative electrode current collector 232) and the positive electrodes 224A, 224B (through the positive electrode current collectors 234A, 234B).

Each of the single-sided positive electrodes 224A, 224B may be the same or different. For example, each of the positive electrodes 224A, 224B may include a positive electroactive material that comprises one or more materials having a spinel structure, such as lithium manganese oxide (Li₍₁₊ₓ₎Mn₂O₄, where 0.1≤x≤1), lithium manganese nickel oxide (LiMn₍₂₋ₓ₎NiₓO₄, where 0≤x≤0.5) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) or Li(NiₓMn_{y}Co_{z}Al_{w})O₂, where 0≤x≤1, 0≤y≤1, 0≤z≤1, 0≤w≤1 and x+y+z+w=1) (e.g., LiMn_{0.04}Ni_{0.90}Co_{0.04}A1_{0.02}O₂)), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄), lithium manganese-iron phosphate (LiMn₁₋ₓFeₓPO₄, where 0<x<0.5), or lithium iron fluorophosphate (Li₂FePO₄F). In certain variations, each of the positive electrodes 224A, 224B may include one or more high-voltage oxides (such as, LiNi_{0.5}Mm_{1.5}O₄, LiCoPO₄), one or more rock salt layered oxides (such as, LiCoO₂, LiNiₓMn_{y}Co_{1-x-y}O₂ (where 0≤x≤1, 0≤y≤1), LiNiₓCO_{y}Al_{1-x-y}O₂ (where 0≤x≤1, 0≤y≤1), LiNiₓMn₁₋ₓO₂ (where 0≤x≤1), Li₁₊ₓMO₂ (where 0≤x≤2 and where M refers to metal elements selected from Mn, Ni, Co, and the like), one or more polyanions (such as, LiV₂(PO₄)₃), and other like lithium transition metal oxides.

For example, in various aspects, each of the positive electrodes 224A, 224B may include one or more positive electroactive material selected from the group consisting of: LiCoO₂, LiNiO₂, LiMnO₂, LiNi_{0.5}Mn_{0.5}O₂, NMC111, NMC523, NMC622, NMC721, NMC811, NCA, NCMA, LiMn₂O₄, LiNi_{0.5}Mn_{1.5}O₄, LiV₂(PO₄)₃, LiFePO₄, LiCoPO₄, LiMnPO₄, LiVPO₄F, LiFeBO₃, LiCoBO₃, LiMnBO₃, Li₂FeSiO₄, Li₂MnSiO₄, LiMnSiO₄F, dilithium (2,5-dilithiooxy)terephthalate, polyimide, and combination thereof. In certain variations, the positive electroactive material particles may be surface coated and/or doped. For example, the positive electroactive material may include LiNbO₃-coated LiNi_{0.5}Mn_{1.5}O₄.

In each instance, the positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black or SuperP™), carbon fibers and nanotubes, graphene, graphene oxide, and the like. Examples of a conductive polymer include polyaniline, polythiophene, polyacetylene, polypyrrole, and the like. In certain aspects, mixtures of the conductive materials may be used.

For example, each of the positive electrodes 224A, 224B may include greater than or equal to about 30 wt. % to less than or equal to about 99 wt. %, and in certain aspects, optionally greater than or equal to about 50 wt. % to less than or equal to about 98 wt. %, of the positive electroactive material; greater than or equal to about 0 wt. % to less than or equal to about 30 wt. %, and in certain aspects, optionally greater than or equal to about 1 wt. % to less than or equal to about 10 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

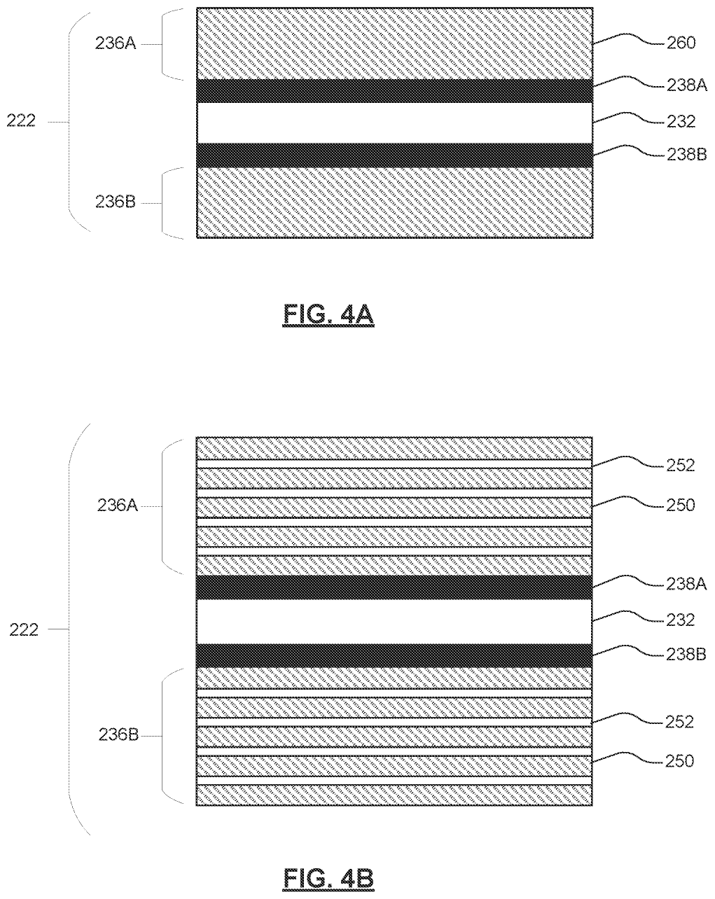

The first and second negative electroactive material layers 236A, 236B may be the same or different. For example, in certain variations, as illustrated in FIG. 4A, each of the first and second negative electroactive material layers 236A, 236B may each include a negative electroactive material layer 260 having a thickness greater than or equal to about 50 μm to less than or equal to about 10,000, optionally greater than or equal to about 50 μm to less than or equal to about 1,000 μm, and in certain aspects, optionally about 400 μm. The double-sided negative electrode 222 may have a total thickness greater than or equal to about 100 μm to less than or equal to about 20,000 μm, and in certain aspects, optionally greater than or equal to about 1,000 μm to less than or equal to about 20,000 μm.

In each instance, the negative electroactive material layer 260 may include a negative electroactive material that comprises lithium, such as, for example, lithium metal. For example, in certain variations, the negative electroactive material layer 260 may be film or layer formed of lithium metal or an alloy of lithium that can be disposed on one or more sides of the negative current collector 232 using a metal sputtering process. Other materials can also be used to form the negative electroactive material layer 260 including, for example, carbonaceous materials (such as, graphite, hard carbon, soft carbon, carbon nanotubes (CNT), and the like) and/or lithium-silicon and silicon containing binary and ternary alloys and/or tin-containing alloys (such as, Si, Li—Si, SiOₓ,Si—Sn, SiSnFe, SiSnAl, SiFeCo, SnO₂, and the like) and/or metal oxides (such as, Fe₃O₄, V₂O₅, SnO, Co₃O₄, and the like) and/or metal sulfides (such as, FeS and the like). In certain variations, lithium-titanium anode materials are contemplated, such as Li₄₊ₓTi₅O₁₂, where 0≤x≤3, including lithium titanate (Li₄Ti₅O₁₂) (LTO).

In each instance, the negative electroactive materials may be optionally intermingled with one or more electrically conductive materials that provide an electron conductive path and/or at least one polymeric binder material that improves the structural integrity of the negative electroactive material layer 260. For example, the negative electroactive material may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black (e.g., Super-P), graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like.

For example, the negative electroactive material layer 260 may include greater than or equal to about 30 wt. % to less than or equal to about 100 wt. %, and in certain aspects, optionally greater than or equal to about 50 wt. % to less than or equal to about 98 wt. %, of the negative electroactive material; greater than or equal to about 0 wt. % to less than or equal to about 30 wt. %, and in certain aspects, optionally greater than or equal to about 0.5 wt. % to less than or equal to about 10 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

In other variations, as illustrated in FIG. 4B, the first and second negative electroactive material layers 236A, 236B may each include a plurality of electroactive material sub-films or sub-layers 250, each sub-film 250 having a thickness greater than or equal to about 10 μm to less than or equal to about 1,000 μm, and in certain aspects, optionally greater than or equal to about 25 μm to less than or equal to about 600 μm, with a thickness variance of about ±3%. For example, in certain variations, as illustrated, the first and second negative electroactive material layers 236A, 236B may each include five sub-films 250. Each sub-film of the plurality of sub-films 250 may be the same or different.

Like the negative electroactive material layer 260, each of the sub-layers 250 may include lithium and/or carbonaceous materials (such as, graphite, hard carbon, soft carbon, carbon nanotubes (CNT), and the like) and/or lithium-silicon and silicon containing binary and ternary alloys and/or tin-containing alloys (such as, Si, Li—Si, SiOₓ, Si—Sn, SiSnFe, SiSnAl, SiFeCo, SnO₂, and the like) and/or metal oxides (such as, Fe₃O₄, V₂O₅, SnO, Co₃O₄, and the like) and/or metal sulfides (such as, FeS and the like). Further, in certain variations, lithium-titanium anode materials are contemplated, such as Li₄₊ₓTi₅O₁₂, where 0≤x≤3, including lithium titanate (Li₄Ti₅O₁₂) (LTO).

Each of the sub-layers 250 may also similarly include an electronically conducting material and/or at least one polymeric binder. For example, each sub-layer 250 may include greater than or equal to about 30 wt. % to less than or equal to about 100 wt. %, and in certain aspects, optionally greater than or equal to about 50 wt. % to less than or equal to about 98 wt. %, of the negative electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 0.5 wt. % to less than or equal to about 15 wt. %, of one or more binders.

As illustrated, subsequent sub-films 250 may be separated by one or more buffer or adhesive layers 252. For example, as illustrated, an adhesive layer 252 may be disposed between of the sequential sub-films 250. In each instance, the one or more adhesive layers 252 may be an ionically and electrically conductive layer that include an admixture of a polymer, an electronically conductive filler, and an ionically conductive filler. For example, each of the one or more adhesive layers 252 may include greater than or equal to about 0.1 wt. % to less than or equal to about 50 wt. % of the polymer and greater than or equal to about 0.1 wt. % to less than or equal to about 50 wt. % of a combination of the electronically conductive filler and the ionically conductive filler. In certain variations, at least one of the one or more adhesive layers 52 may have a mass ratio of the polymer:electronically conductive filler:ionically conductive filler of about 3:1:1.

The electrically conductive filler may include a carbonaceous material (such as, Super-P, carbon black, graphene, carbon nanotubes, carbon nanofibers, and the like) and/or metal powders (such as, silver (Ag), aluminum (Al), nickel (Ni), and the like). The ionically conductive filler may include a lithium-ion fast conductive material, such as lithium aluminum titanium phosphate (LATP), lithium lanthanum zirconate (LLZO), Li₁₊ₓAlₓGe₂₋ₓ(PO₄)₃ (where 0≤x≤2) (LAGP), and the like. The polymer may be solvent resistant and provides good adhesion, such as epoxy, polyimide (polyamic acid), polyester, vinyl ester, and combinations and the like. In other variations, the polymer may include a thermoplastic polymer, such as polyvinylidene fluoride (PVdF), polyamide, silicone, acrylic, and combinations and the like.

Certain features of the current technology are further illustrated in the following non-limiting examples.

### EXAMPLE 1

An example half coin cell may be prepared in accordance with various aspects of the present disclosure. The example cell may include a positive electrode, a negative electrode, and a separator disposed between the positive and negative electrodes. The positive electrode may include a plurality of electroactive material sub-films or sub-layers and one or more buffer layers disposed between subsequent sub-films of the plurality of electroactive material sub-films. For example, the positive electrode may include four sub-films and three buffer layers disposed therebetween. Each of the sub-films may include LiMn_{0.7}Fe_{0.3}PO₄, Super-P, vapor grown carbon fibers (VGCF), and polytetrafluoroethylene (PTFE) in a mass ratio of about 95:2:1:2. Each of the buffer layers may include polyacrylate (PAA) and Super-P in a mass ratio of about 2:1 and may have a thickness of about 240 μm. The positive electrode including the plurality of electroactive material sub-films and the one or more buffer layers may have a total thickness of about 1,000 μm. The negative electrode may include a lithium foil having a thickness of about 450 μm. The example cell may further include an electrolyte that includes 1M lithium hexafluorophosphate (LiPF₆) in a co-solvent mixture. The co-solvent mixture may have a volume ratio of about 3:7 of ethylene carbonate (EC) and ethylmethylcarbonate (EMC).

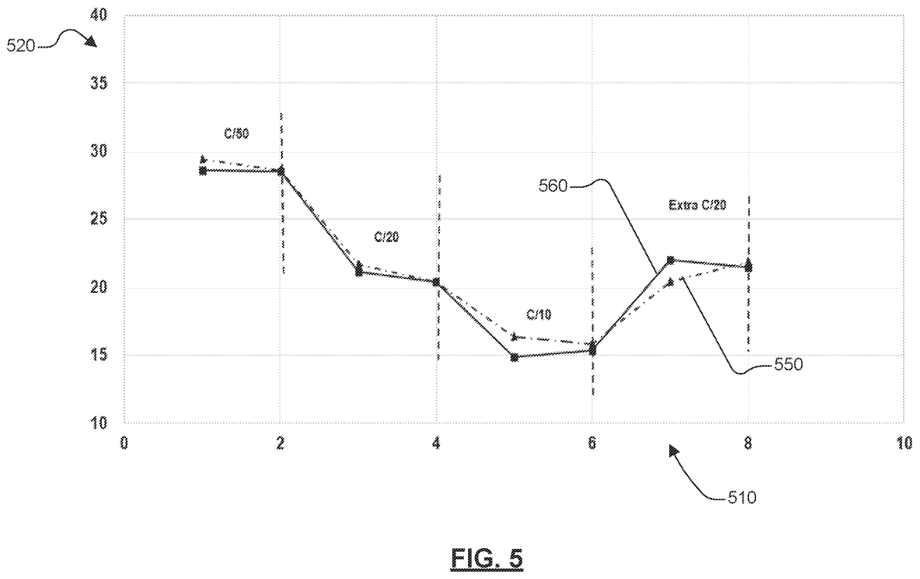

FIG. 5 illustrates the charge/discharge capacity retention for the example half-cell. Line 550 represents charge capacity and line 560 represents discharge capacity. The example half-cell was operated in a voltage window greater than or equal to about 2.5 V to less than or equal to about 4.3 V and was cycled at C/50 for 2 cycles, C/20 for 2 cycles, C/10 for 2 cycles, and C/20 for 2 cycles. The x-axis 510 represents cycle number. The y-axis 520 represents capacity (mAh).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, the electrochemical cell comprising:
a double-sided electrode comprising a first electroactive material layer, a second electroactive material layer, and a current collector disposed between the first and second electroactive material layers;
a first single-sided electrode substantially aligned with the first electroactive material layer;
a first separator physically separating the first single-sided electrode and the first electroactive material layer;
a second single-sided electrode substantially aligned with the second electroactive material layer; and
a second separator physically separating the second single-sided electrode and the second electroactive material layer.

2. The electrochemical cell of claim 1, wherein each of the first and second electroactive material layers comprises a positive electroactive material, and each of the first and second single-sided electrodes comprises a negative electroactive material.

3. The electrochemical cell of claim 1, wherein each of the first and second electroactive material layers comprises a negative electroactive material, and each of the first and second single-sided electrodes comprises a positive electroactive material.

4. The electrochemical cell of claim 1, wherein the current collector is a first current collector, a second current collector is disposed on or adjacent to the first single-sided electrode, and a third current collector is disposed on or adjacent to the second single-sided electrode.

5. The electrochemical cell of claim 1, wherein the first electroactive material layer comprises a plurality of first electroactive material sub-films and a plurality of first buffer layers disposed between adjacent electroactive sub-films of the plurality of first electroactive sub-films.

6. The electrochemical cell of claim 5, wherein the second electroactive material layer comprises a plurality of second electroactive material sub-films and a plurality of second buffer layers disposed between adjacent electroactive material sub-films of the plurality of second electroactive sub-films.

7. The electrochemical cell of claim 6, wherein the plurality of first buffer layers and the plurality of second buffer layers each comprises a polymer, an electronically conductive filler, and an ionically conductive filler.

8. The electrochemical cell of claim 1, wherein the current collector has one or more surfaces coated with an adhesive layer having a thickness greater than or equal to about 0.05 μm to less than or equal to less than or equal to about 100 μm.

9. The electrochemical cell of claim 8, wherein the adhesive layer comprises a polymer and an electronically conductive filler.

10. The electrochemical cell of claim 1, wherein the electrochemical cell further comprises:
a first terminal separator disposed on or adjacent to an exposed surface of the first single-sided electrode; and
a second terminal separator disposed on or adjacent to an exposed surface of the second single-sided electrode.

11. An electrochemical cell that cycles lithium ions, the electrochemical cell comprising:
a double-sided electrode comprising a first electroactive material layer, a second electroactive material layer, and a current collector disposed between the first and second electroactive material layers, wherein
the first electroactive material layer comprises a plurality of first electroactive material sub-films and a plurality of first buffer layers disposed between adjacent electroactive sub-films of the plurality of first electroactive sub-films, and
the second electroactive material layer comprises a plurality of second electroactive material sub-films and a plurality of second buffer layers disposed between adjacent electroactive material sub-films of the plurality of second electroactive sub-films;
a first single-sided electrode substantially aligned with the first electroactive material layer;
a first separator physically separating the first single-sided electrode and the first electroactive material layer;
a second single-sided electrode substantially aligned with the second electroactive material layer; and
a second separator physically separating the second single-sided electrode and the second electroactive material layer.

12. The electrochemical cell of claim 11, wherein the current collector is a first current collector, a second current collector is disposed on or adjacent to the first single-sided electrode, and a third current collector is disposed on or adjacent to the second single-sided electrode.

13. The electrochemical cell of claim 11, wherein the plurality of first buffer layers and the plurality of second buffer layers each comprises a polymer, an electronically conductive filler, and an ionically conductive filler.

14. The electrochemical cell of claim 11, wherein the current collector has one or more surfaces coated with an adhesive layer having a thickness greater than or equal to about 0.05 μm to less than or equal to less than or equal to about 100 μm.

15. The electrochemical cell of claim 11, wherein the electrochemical cell further comprises:
a first terminal separator disposed on or adjacent to an exposed surface of the first single-sided electrode; and
a second terminal separator disposed on or adjacent to an exposed surface of the second single-sided electrode.

16. A double-sided electrode for an electrochemical cell that cycles lithium ions, the electrode comprising:
a current collector having a first surface substantially parallel with a second surface;
a first electroactive material layer disposed on or adjacent to the first surface of the current collector, wherein the first electroactive material layer comprises a plurality of first electroactive material sub-films and a plurality of first buffer layers disposed between adjacent electroactive sub-films of the plurality of first electroactive sub-films; and
a second electroactive material layer disposed on or adjacent to the second surface of the current collector, wherein the second electroactive material layer comprises a plurality of second electroactive material sub-films and a plurality of second buffer layers disposed between adjacent electroactive material sub-films of the plurality of second electroactive sub-films,
wherein the double-sided electrode has a total thickness greater than or equal to about 100 μm to less than or equal to about 20,000 μm.

17. The double-sided electrode of claim 16, wherein each of the first and second electroactive material layers comprise a positive electroactive material.

18. The double-sided electrode of claim 16, wherein each of the first and second electroactive material layers comprises a negative electroactive material.

19. The double-sided electrode of claim 16, wherein the plurality of first buffer layers and the plurality of second buffer layers each comprises a polymer, an electronically conductive filler, and an ionically conductive filler.

20. The double-sided electrode of claim 16, wherein each of the plurality of first electroactive material sub-films and the plurality of second electroactive material sub-films respectively has a thickness greater than or equal to about 100 μm to less than or equal to about 1,000 μm.
